(19) United States
(12) Patent Application Publication
(10) Pub. No.: US 2008/0103631 A1
(43) Pub. Date: May 1, 2008

(54) METHOD AND SYSTEM FOR COLLECTING DATA FROM INTELLIGENT ELECTRONIC DEVICES IN AN ELECTRICAL POWER SUBSTATION

(75) Inventors: Ajay Koliwad, Ft. Washington, PA (US); Gururaj Upadhye, Old Bridge, NJ (US)

Correspondence Address: NIXON & VANDERHYE P.C., 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 11/555,482

(22) Filed: Nov. 1, 2006

(51) Int. Cl. G05D 11/00

(52) U.S. Cl. 700/286

(57) ABSTRACT

A system for providing power substation event data to one or more master stations including: a plurality of intelligent electronic devices (IEDs) monitoring electrical power systems in a power substation, wherein each IED collects event data regarding conditions of a monitored electrical power system and queues the event data for transmission; a data concentrator in data communication with the IEDs, the concentrator including a database for storing IED event data transmitted from the event data queued in the IEDs and event queues in the concentrator for buffering IED event data from the database, and at least one master station in data communication with the concentrator, wherein the master station reads IED event data from event queues in the concentrator, and further the concentrator clears the event queues after the data is read by the master station.

### BACKGROUND OF THE INVENTION

This invention relates to methods and systems for collecting data from intelligent electronic devices (IEDs) at electrical substations for power transmission systems.

An electrical substation is a subsidiary station of an electricity generation, transmission and distribution system where voltage is transformed from high to low or the reverse using transformers. IEDs monitor and protect substations, and collect data regarding the electrical distribution system. IEDs may detect conditions and events, e.g., disturbances and faults, in the electrical power distribution occurring at the substation. In addition, IEDs may collect data regarding the operation of the substation and the electrical power at the substation. The IEDs may periodically report the collected data, and prepare specific reports such as chronological reports of conditions and events, and reports of protection events that occurred in the substation.

Data concentrator computer devices have been used to collect data from the IEDs at each substation. An exemplary data concentrator is the IP-Server™ sold by the General Electric Company. The IP-Server™ communication device is a data gateway the polls data, e.g., metering, status, event and fault report data, collected by IEDs. The IP-Server™ summaries the data collected from the IEDs and provides a single source from which the data may be accessed, such as via a web-accessible interface.

Master stations are control stations for electrical substations. The master stations are typically remote from the electrical substation and each data from the IEDs is reported to one or more master station. Each master station needs to see data from an IED once and only once. To receive the same IED data more than once may cause the master station to record phantom events and treat the duplicate data as multiple events.

The information from the IED event reports, and other data collected by the IEDs, is used to determine operating decisions regarding electrical power distribution, schedule and manage power outages and for data reporting requirements. The reporting requirements are stringent, as is typical for supervisory control and data acquisition (SCADA) systems. The reporting requirements vary depending on several factors, including the type of events and conditions to be reported.

Certain events at a substation are to be reported as soon as they are detected by an IED. To accommodate requirements for real time data reporting, data concentrators often have real time communication paths to IEDs and maintain real time databases.

The data collected from IEDs by a data concentrator is reported to a master station, which may be remote to the concentrator, and some or all of the IEDs. The reports collected by the IEDs may be properly formatted to ensure that the data is properly passed by the data concentrator to the master stations. Further, there is a need to distribute IED data to more than one master station. Distributing IED data to multiple master stations increases the difficulty of ensuring that the same IED data is not read more than once by the same master station. Accordingly, there is a need for a data concentrator that can affirmatively ensure that data from IEDs are reported to each master station once and only once.

### BRIEF DESCRIPTION OF THE INVENTION

A system has been developed to employ a data concentrator to poll IEDs for data of events, e.g., disturbance reports, and store the IED data in a real time database maintained by the concentrator. The IED data is made available by the concentrator to several master stations simultaneously by placing the data on an active queue. Once the IED is transmitted to all master stations interested in the data, the IED data is removed from the active queue and is not transmitted again.

A system has been developed for providing power substation event data to one or more master stations including: a plurality of intelligent electronic devices (IEDs) monitoring electrical power systems in a power substation, wherein each IED collects event data regarding conditions of a monitored electrical power system and queues the event data for transmission; a data concentrator in data communication with the IEDs, the concentrator including a database for storing IED event data transmitted from the event data queued in the IEDs and event queues in the concentrator for buffering IED event data from the database, and at least one master station in data communication with the concentrator, wherein the master station reads IED event data from event queues in the concentrator, and further the concentrator clears the event queues after the data is read by the master station.

A system has been developed for providing power substation event data to one or more master stations comprising: a plurality of intelligent electronic devices (IEDs) monitoring electrical power systems in a power substation, each IED includes a data buffer and wherein each IED collects event data regarding conditions of a monitored electrical power system and queues the event data in the buffer for transmission; a data concentrator in data communication with the IEDs, said concentrator including a real time database for storing IED event data transmitted in real time from the buffers in the IEDs and logical remote units (LRU), wherein each LRU buffers IED event data retrieved from the database and each LRU corresponds to a respective one of the IEDs such that each LRU buffers event data from said respective one IED, and at least one master station in data communication with the concentrator, wherein said master station reads IED event data from event queues in the concentrator, and further the concentrator clears the event queues after the data is read by the master station.

A method has been developed for collecting data from intelligent electronic devices in an electrical power transmission substation, said method comprising: monitoring conditions of substation using intelligent electronic devices (IED), wherein each IED monitors a particular condition of the substation; collecting event data in the IEDs, wherein the event data is indicative of a change of the particular condition; queuing the event data in a buffer of the IED; transmitting the queued event data from each IED to a data concentrator; storing the transmitted event data in a database maintained by the concentrator; queuing the event data from the database in a buffer in the concentrator, wherein the buffer in the concentrator corresponds to one of the IEDs and buffers data collected from the one of the IEDs; reading the event data queued in the database by a master station, and clearing the event data from the queue in the database after the master station reads the data.

### BRIEF DESCRIPTION OF THE DRAWINGS

FIG. 1 is a schematic diagram of IEDs, an data concentrator and master stations.

FIG. 2 is a schematic diagram of a data concentrator with logical remote units emulating IEDs and in communication with master stations.

FIGS. 3 and 4 show an exemplary flow chart of a process for collecting data from IEDs, databasing IED data on a data concentrator, emulating the IEDs using LRUs, and allowing master stations to access the LRUs to collect IED data.

### DETAILED DESCRIPTION OF THE INVENTION

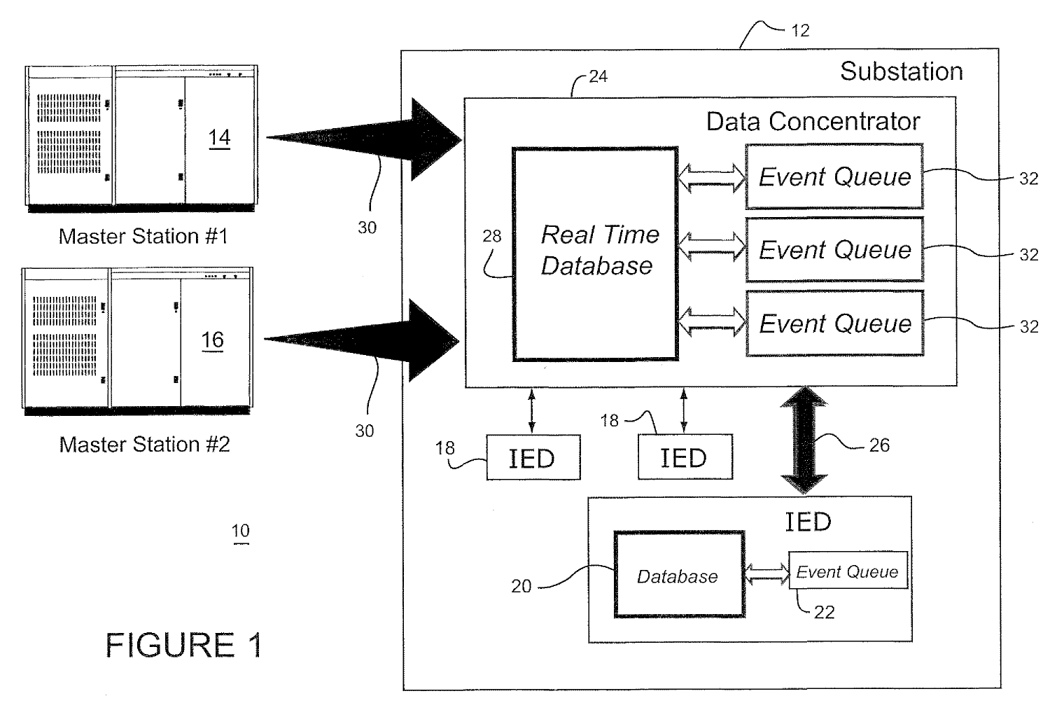

FIG. 1 is a schematic diagram of a data collection system 10 for collecting data from an electrical substation 12 and providing the data to master stations 14, 16. The master stations may access multiple substations. The master stations provide control and monitoring functions for one or more substations in an electrical power distribution grid. Exemplary master stations include: Regional SCADA (Supervisory Control and Data Acquisition) Master; EMS (Energy Management System) Master; and Local and/or Remote Maintenance and Configuration Master(s). The master stations 14, 16 use data from the substations to monitor and control electrical power distribution and the power system components at each of the substations.

A substations 12 is typically a subsidiary station of an electricity generation, transmission and distribution system where voltage is transformed from high to low or the reverse using transformers. Substations generally contain one or more transformers, and have switching, protection and control equipment. In a large substation circuit breakers are used to interrupt any short-circuits or overload currents that may occur on the network. A typical substation will contain line termination structures, high-voltage switchgear, one or more power transformers, low voltage switchgear, surge protection, controls, and metering. Other devices such as power factor correction capacitors and voltage. The devices, e.g., transformer, switches and breakers, in a substation are monitored and controlled by intelligent electronic devices (IED) 18.

An IED 18 is typically a microprocessor based controller for a power system equipment. An IED may receive and temporarily store data from sensors monitoring power equipment. An IED may also issue control commands to the equipment, such as tripping circuit breakers if an excessive condition occurs with respect to electrical voltage, current and frequency anomalies. IEDs may also raise and lower voltage levels of power system equipment. Common types of IEDs include protective relaying devices, load tap changer controllers, circuit breaker controllers, capacitor bank switches, and voltage regulators.

IEDs monitor power equipment and collect data regarding the operation of the equipment. For example, IEDs collect data regarding events that occur in the equipment that they monitor. Events may include disturbances in the electrical voltage, current or frequency in the power equipment, a change in the operating state of the power equipment, e.g., a switch of a circuit breaker, and a failure condition in the power equipment. The data collected by the IED regarding the power equipment monitored by the IED is referred to herein as IED data.

Typically, each IED includes a data acquisition device to collect data from the component being monitored, a control device for issuing commands to the component, a database 20 to store the collected data and an event queue buffer 22. The buffer temporarily stores data ready to be transmitted to a remote device, such as a data concentrator 24. A typical substation IED has a single event buffer 22 to store IED event data. Once the event data is read for transmission to the data concentrator, the buffer 22 in the IED is cleared of the transmitted data. The cleared buffer is available for the next IED event data. The IED event data may be loaded into the buffer in a chronological sequence of when the data event occurred.

The IED communicates data from the substation to a data concentrator 24 via a communication link 26. Each data concentrator is assigned to a group of IEDs, such as all IEDs in a substation. The communication link 26 between the concentrator and IED may be a wired or wireless link, an network and/or internet link, e.g., TCP/IP network protocol, other data transmission path. The data concentrator 24 collects data from the plurality of IEDs each of which has a data communication link to the concentrator. The data concentrator, e.g. a GE IP-Server™, may be located on site of the substation or may be remote to the substation. The data concentrator may monitor all IEDs in a single substation, some but not all IEDs in a substation, or monitor IEDs at a plurality of substations. The data concentrator may monitor, poll and collect IED data. The IP-Server™ summaries the data collected from the IEDs and provides a single source from which the data may be accessed, such as via a web-accessible interface.

The data concentrator 24 reads the event buffer in each IED assigned to the concentrator. The data concentrator makes the data available to a plurality of master stations 14, 16. The master stations obtain IED data from the data concentrator rather than directly from the IED. The data concentrator makes IED data available to the master stations.

To collect IED event data, the data concentrator reads the IED event buffers. The data concentrator collects the event data from the IEDs and stores the data in a real time database 28 maintained by the data concentrator. The IED data may be obtained by having the data concentrator regularly poll the event queue 22 in each IED. Alternatively, the IED may notify the concentrator of a data event to trigger the concentrator to read the IED event queue buffer 22. As the event data is transmitted from each IED to the data concentrator, the event data is cleared from the corresponding IED event queue buffer 22. By clearing the buffer 22 after the concentrator reads the IED event data, the risk that the concentrator reads duplicative IED event data is minimized.

The real time database 28 stores the IED event data. Preferably, the entirety of the IED event data from the IED queue buffer 22 is stored in the real time database. Further, the IED event data is preferably transmitted in real time or near real time from the IED to the data concentrator. The real time transmission ensures that timely event data is stored in the database 28. The converter may log the time of transmission of the IED event data from the IED. This logged time may be treated as the time that the event occurred, assuming that the event data is transmitted in real time or near real time by the IED. Logging the transmission of real time event data is helpful because, for example, the event data does not include event time information. The logged time of the event data may be used by the database 28 to determine the sequence of event data to be loaded from the database to queue event storage locations 32.

The IED event data is stored in the real time database 28 so that the master stations 14, 16 can read the IED event data. The master stations communicate with the data converter over data communication channels 30, which may be wired or wireless, and via internet pathways. The data converter may be configured to be accessible via that internet to allow remote access from the master stations. The master stations may be configured to read IED data and, particularly, to access IED event queue buffers to access the IED event data. To accommodate the master stations, the data concentrator may store the IED data in the same (or compatible) data format as used for IED event data in the event queue buffer 22 of an IED. Accordingly, the real time database 28 may store data in a format that is the same or compatible to the IED event data format used in the IEDs.

To facilitate access by the master stations, the concentrator 24 may allocate electronic memory to IED event data queues 32 that emulate the event queues 22 of the IEDs. Each event queue 32 may be a specific electronic memory storage location that is allocated for IED event data from a particular IED. The event data may be placed in the event queue promptly, e.g., near real time, after the data is transmitted from the IED to the concentrator 24. Such prompt posting of IED event data in the event queues 32 provides master stations with real time or near real time data from IEDs. The sequence event data in the queue 32 may be the same sequence of event data in the corresponding IED event data queue 22.

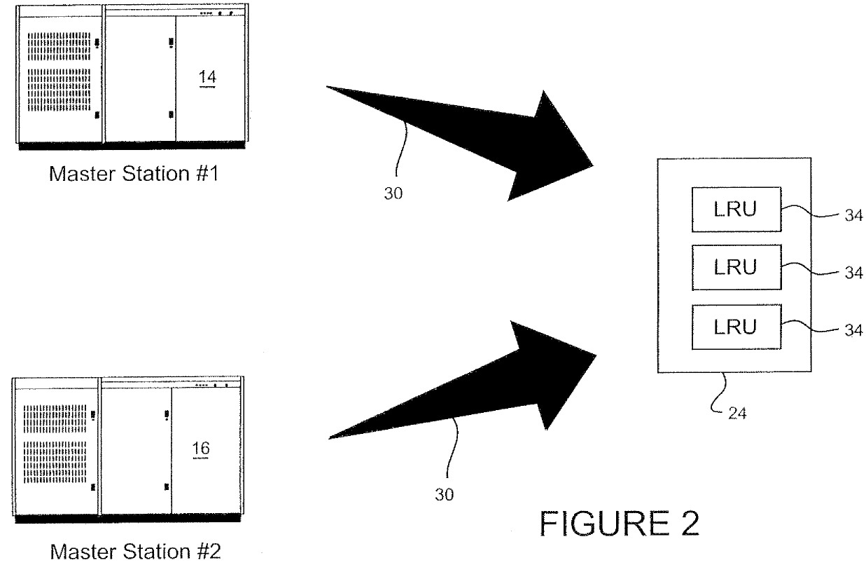

The event queues 32 allocated in the memory of the converter in configured as a logical remote unit (LRU in FIG. 2). Each event queue/LRU is maintained separately by the converter as a buffer for IED data. The LRUs may emulate the event queues 22 of the IEDs. There may be one (or possibly more than one) LRU assigned to each IED 18 and, in particular, to each IED event queue 22. For each IED 18, the data converter causes IED event data to be stored in near real time with data transmission (via link 26) in the real time database 28 and sequentially stored in the event queue 32 (LRU) corresponding to the IED.

FIG. 2 is a schematic diagram of a data concentrator 24 with LRUs 34 emulating IEDs, and master stations 14, 16 that poll the LRUs to collect the IED event data, preferably in near real time to the occurrence of the event that is the subject of the event data. Each LRU emulates the event queue of a specific IED. Each LRU emulates an IED such that to the master stations, the LRU appears to be the IED.

The LRU is maintained in memory of the data concentrator. The concentrator polls and monitors the actual IEDs to collect IED data. Further, the IEDs will promptly transmit data to the concentrator if an immediately reportable event occurs at the substation. Data in the IED is temporarily stored by the concentrator in an event queue corresponding to the IED. The concentrator reads the data from the event queue. The concentrator stores the IED data in a real time database. The concentrator recreates the event queue of the IED using the data in the real time database. An event queue is created corresponding to each IED monitored by the data concentrator.

The master stations access the data concentrator by requesting data from the event queues of selected IEDs. Each master station has a group of IEDs for which the master station collects data. In accessing the concentrator, each master station polls a selected group of LRUs corresponding to the IEDs for which the master station is seeking data. Each selected LRU has data in its queue that is read by the master station. Once the data concentrator determines that the master station has read the data in the queue, the data is cleared from the queue and the next sequential IED event data is stored in the queue for the LRU.

Each master station typically has a need to access specific IED data once and only once. The master station may not have the ability to determine whether it is reading IED data that it has read before or new IED data. A master station may operate under an assumption that when it reads IED data the data is new and has not been read by that master station previously. To avoid having a master station read the same IED data more than once, the data concentrator 24 clears the IED data from the event queue 32 in the LRU 34 after it is read by a master station.

Because multiple master stations may need to access the same IED data, the data concentrator may wait to clear IED data until after all master stations assigned to collect the IED data have read the data and/or until expiration of a predetermined time period. The LRU clear data time period, e.g., 10 seconds, 1 minute or 1 hour, would be sufficient to allow all master stations to poll the data concentrator for IED data. Further, the master stations are programmed to poll the data converter on the same cycle time as the LRU clear data time period, but the out of phase with that period. For example, the master stations may be programmed to each access the data converter near the middle of the clear data time period.

Clearing the data from the event queue may not cause the IED data to be deleted from the real time database 28 of the data concentrator. The database 28 may store IED event data after the data is cleared from the event queue.

One approach to allowing multiple master stations to access IED event data is to establish multiple LRUs 34 for each IED, and assign each LRU to a unique master station. The master stations would be assigned to access a particular LRU to obtain IED event data. Further, only one master station would be assigned to any one LRU. All of the LRUs corresponding to a particular IED buffer the same IED event data and in substantially the same sequence. Each LRU clears its event queue buffer 32 after their corresponding master station accesses the LRU. The concentrator then load the next IED event data to the event queue 32 from data logged into and stored in the real time database.

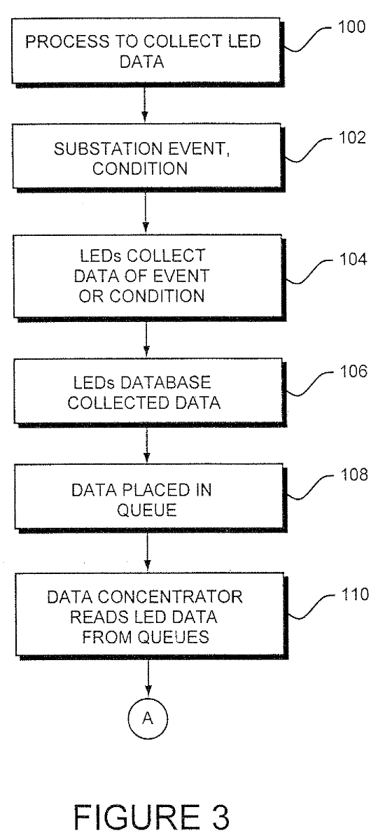

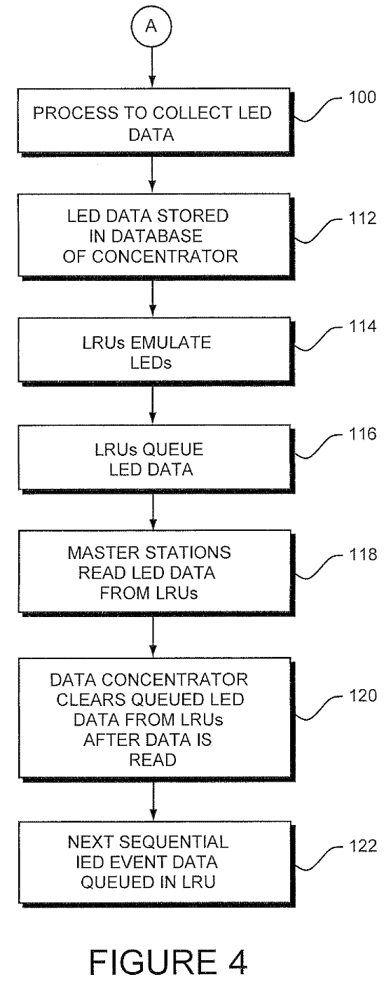

FIGS. 3 and 4 show an exemplary flow chart of a process 100 for collecting data from IEDs, databasing IED data on a data concentrator, emulating the IEDs using LRUs, and allowing master stations to access the LRUs to collect IED data. In step 102, there is an occurrence of a substation event, condition change or circumstance that generates data for an IED at the substation. For example, a circuit breaker may trip that is monitored by a circuit breaker IED. The circuit breaker trip is reported as an IED event data. The IED monitoring the substation event, condition or circumstance collects the data in step 104. The IED stores the collected data in its database, in step 106, and buffers the event data for transmission to the data concentrator in step 108.

The data concentrator reads the IED data from the queues 22 in step 110. The transmitted IED data is stored in the real time database 28 and made ready to be buffered in the LRU queue 32, in step 112. The LRUs emulate the queue buffers of IEDs so that the master stations treat the concentrator as virtual IED queues, in step 114. The IED event data is queued in the LRUs, step 116.

The master stations read IED event data by accessing the LRUs emulating the IEDs of interest to the master station, in step 118. When the all of the master stations scheduled to read the data have read the event data in an LRU, the data is cleared (step 120) from the event queue buffer 32 and the buffer is ready to receive the next sequential IED event data (step 122). The sequence of data is the same as the sequence of data loaded into the event queue buffer of the corresponding IED.

Some of the beneficial technical effects of the process and system disclosed herein include using a data concentrator for centralized data storage of IED data, e.g., power system data collected from IEDs installed at a plurality of remote substations; real time collection of IED and storing the data in a real time database in the concentrator; creating LRUs at the data concentrator to queue IED data for master stations that access the data at the concentrator; using the LRUs to emulate the data queues in the IEDs to allow the master stations to read near real time IED data by accessing the LRUs at the concentrator, and clearing the IED data read from the LRUs to safeguard against redundant reading of data.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A system for providing power substation event data to at least one master station comprising:
a plurality of intelligent electronic devices (IEDs) monitoring electrical power systems in a power substation, wherein each IED collects event data regarding conditions of a monitored electrical power system and queues the event data for transmission;
a data concentrator in data communication with the IEDs, said concentrator including a database for storing IED event data transmitted from the event data queued in the IEDs and event queues in the concentrator for buffering IED event data from the database, and
the at least one master station in data communication with the concentrator, wherein said master station reads IED event data from event queues in the concentrator, and further the concentrator clears the event queues after the data is read by the master station.

2. A system as in claim 1 wherein the event queues in the data concentrator are included in logical remote units (LRUs).

3. A system as in claim 2 wherein a plurality of LRUs are assigned to one of said IEDs.

4. A system as in claim 1 wherein the event queues each correspond to a specific IED and emulates the queuing of data by the IED.

5. A system as in claim 1 wherein the IEDs are included in a single substation.

6. A system as in claim 5 wherein the concentrator is within said substation.

7. A system for providing power substation event data to at least one master station comprising:
a plurality of intelligent electronic devices (IEDs) monitoring electrical power systems in a power substation, each IED includes a data buffer and wherein each IED collects event data regarding conditions of a monitored electrical power system and queues the event data in the buffer for transmission;
a data concentrator in data communication with the IEDs, said concentrator including a real time database for storing IED event data transmitted in real time from the buffers in the IEDs and logical remote units (LRU), wherein each LRU buffers IED event data retrieved from the database and each LRU corresponds to a respective one of the IEDs such that each LRU buffers event data from said respective one IED, and
the at least one master station in data communication with the concentrator, wherein said master station reads IED event data from event queues in the concentrator, and further the concentrator clears the event queues after the data is read by the master station.

8. A system as in claim 7 wherein the LRUs each include an event queue which emulates an event queue in the respective one IED.

9. A system as in claim 8 wherein a plurality of LRUs are assigned to one of said IEDs.

10. A system as in claim 7 wherein the IEDs are included in a single substation.

11. A system as in claim 7 wherein at least one of the IEDs is one of a group consisting of a controller for a protective relay device, a load tap changer controller, a circuit breaker controller, a capacitor bank switch controller and a voltage regulator controller.

12. A system as in claim 10 wherein the concentrator is within said substation.

13. A method for collecting data from intelligent electronic devices in an electrical power transmission substation, said method comprising:
monitoring conditions of substation using intelligent electronic devices (IED), wherein each IED monitors a particular condition of the substation;
collecting event data in the IEDs, wherein the event data is indicative of a change of the particular condition;
queuing the event data in a buffer of the IED;
transmitting the queued event data from each IED to a data concentrator;
storing the transmitted event data in a database maintained by the concentrator;
queuing the event data from the database in a buffer in the concentrator, wherein the buffer in the concentrator corresponds to one of the IEDs and buffers data collected from the one of the IEDs;
reading the event data queued in the database by a master station, and
clearing the event data from the queue in the database after the master station reads the data.

14. A method as in claim 13 wherein a plurality of master stations read the same event data queued in the concentrator.

15. A method as in claim 14 wherein the queue is cleared after the multiple master stations read the event data.

16. A method as in claim 13 wherein event data is queued in the database in an electronic memory location allocated to the IED from which the event data was transmitted.

17. A method as in claim 16 wherein at least one master station accesses the electronic memory location to read the event data to obtain event data from the IED.

18. A method as in claim 16 wherein the electronic memory location is a plurality of electronic memory locations each queuing event data transmitted from the same IED.

19. A method as in claim 18 wherein each of the plurality of electronic memory locations is access by a different master station.

20. A method as in claim 13 further comprising loading a next event data into the queue after the queue is clear, and the next event data corresponds to a sequence of event data transmitted by the IED.
